(19) United States
(12) Patent Application Publication
(10) Pub. No.: US 2025/0317487 A1
(43) Pub. Date: Oct. 9, 2025

(54) DELEGATING GROUP OWNERSHIP IN PEER-TO-PEER NETWORKS

(71) Applicant: Cypress Semiconductor Corporation, San Jose, CA (US)

(72) Inventors: Siddeshi Annapura Prakash, Bangalore (IN); Yashas Nanjungud Suryanarayana Iyer, Bangaluru (IN)

(73) Assignee: Cypress Semiconductor Corporation, San Jose, CA (US)

(21) Appl. No.: 18/625,499

(22) Filed: Apr. 3, 2024

(51) Int. Cl. H04L 67/104; H04W 84/18

(52) U.S. Cl. CPC H04L 67/1051; H04W 84/18

(57) ABSTRACT

Methods and systems for delegating group ownership in P2P networks. The disclosed method includes, among other things, responsive to a pending disconnection of the first station device from the P2P network, identifying, from a list of the plurality of station devices maintained by the first station device, a second station device to delegate ownership of the P2P network, and delegating ownership from the first station device to the second station device.

### TECHNICAL FIELD

This disclosure relates to peer-to-peer (P2P) networks, and, more specifically, to delegating group ownership in P2P networks.

### BACKGROUND

Wireless local area network (WLAN) peer-to-peer (P2P) networks is a type of wireless network configuration in which a variety of client devices, also known as stations devices, communicate directly with each other without relying on a centralized access point, such as a router. It serves as a flexible way of generating temporary networks, small home networks, in situations where a central access point is not readily available. Typically, these WLAN P2P networks facilitate file sharing between station devices.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A is a block diagram of an exemplary illustration of a station device, in accordance with implementations of the present disclosure.

FIG. 1B is a block diagram of an exemplary illustration of an environment in which one or more station devices establishes a WLAN P2P network, in accordance with implementations of the present disclosure.

FIG. 2 illustrates the established WLAN P2P network based of different delegation techniques, in accordance with implementations of the present disclosure.

FIG. 3 illustrates a ranking list used to facilitate delegating group ownership from one station device to another station device, in accordance with implementations of the present disclosure.

FIG. 4 depicts a flow diagram of an example method for delegating group ownership from one station device to another station device, in accordance with implementations of the present disclosure.

FIG. 5 depicts a flow diagram of an example method for maintaining a ranking list for delegating group ownership from one station device to another station device, in accordance with implementations of the present disclosure.

### DETAILED DESCRIPTION

Aspects of the present disclosure relate to delegating group ownership in P2P networks. WLAN P2P network (referred to as P2P network for simplicity) refers to a network of interconnected nodes (e.g., station devices) that establishes WLAN connection without any intermediary wireless access point, router, or internet connection. P2P networks are established by station devices discovering one another. Once station devices have discovered each other, a station device is designated as a group owner (GO). This is usually determined through a negotiation process, which can be initiated by any of station devices. The negotiation process decides which station device (STA) will be the GO based on factors, such as, power source (battery-powered versus plugged in) and network conditions. The STA designated as GO (e.g., GO) is responsible for managing the network settings and controlling access to the network (e.g., accepting new connections or disconnecting existing ones). Once the P2P network is established, data can be transferred directly between station devices. This can include file sharing, media streaming, or internet connectivity sharing if the GO has access to another network (like a mobile data connection).

Typically, station devices not designated as GO (or STA designated as group client (GC)) (e.g., GCs) may wish to leave the P2P network or to terminate the P2P network session. When GCs leave the P2P network, they disconnect from the P2P network without affecting the P2P network itself (i.e., the GO and other GCs can continue to communicate within the P2P network). However, in current implementations, when GO wishes to leave to the P2P network, the P2P network is disbanded due to the inability for the GO to delegate its ownership of the P2P network to another GC. Similarly, when a new station device joins the P2P network that is better suited as GO, the new station device is unable to be designated as GO.

In current implementations, a GO may delegate its ownership of the P2P network to a GC based on station device's capabilities. More specifically, when the GO wishes to leave the P2P network, the GO sends a request to obtain an intent value from each GC of the P2P network. The intent value sent by each GC of the P2P network may be based on details such as cross connections, services offered, device capabilities, etc. The intent values received by the GO from each GC of the P2P network may be used to select a GC among the GCs of the P2P network (e.g., a new GO). The method of selecting the new GO may vary depending on the algorithm used (e.g., selecting the GC with the highest intent value).

Once the new GO is selected from among the GCs of the P2P network, the GO sends a delegation confirmation to the new GO. Upon receiving, by the new GO, the delegation confirmation from the GO, the new GO accepts or rejects the delegation confirmation. If the new GO rejects the delegation confirmation, the GO negotiates with other GCs of the P2P network. If the new GO accepts the delegation confirmation, the GO performs a handshake with the new GO to send designation related information, such as, dynamic host configuration protocol (DHCP) server details, a peer-to-peer device and interface address, a group identification, a client state, etc. The GO also sends a notification to other GCs of the P2P network indicating the new GO as a GO.

While the current implementation provides an ability for a station device of the P2P network (e.g., a GO) to delegate its ownership of the P2P network to another station device (e.g., a new GO) based on its capabilities, one or more GCs of the P2P network may not be within a communication range of the new GO. Accordingly, the one or more GCs of the P2P network that are not within the communication range of the new GO, but were within the communication range of the GO are no longer able to communicate with other GCs of the P2P network. As a result, if the communication range of the P2P network associated with the new GO includes a small subset of the GCs, the delegation of ownership from the GO to the new GO would be equivalent to disbanding of the P2P network.

Aspects and embodiments of the present disclosure address these and other limitations of the existing technology by creating and maintaining a list (e.g., a ranking list) of the one or more station devices (e.g., STAs) to facilitate delegation of the role of GO from a GO to another GC. The ranking list includes, for each GC, an intent value, a reachability value, and a ranking score calculated based on the intent value and the reachability value. The intent value is a predefined value that indicates a preference of the GO. The reachability value is a value that indicates a number of GCs that are communicatively accessible by a respective GC. The reachability value may be determined using various methods, such as, reading from, among other information, various packets, frames, and/or messages transmitted by nearby GCs. The intent value, and in some embodiments the reachability value as well, are received, by a GO, from the one or more GCs during negotiation. The GO periodically updates, at predetermined time intervals, the ranking list based on reachability valued transmitted periodically by each GC to the GO.

During delegation of the role of GO from a GO to a GC, the GO obtains, from the ranking list, a GC (or station device) having a highest-ranking score (e.g., the highest ranked station or the highest ranked STA). In some embodiments, additional logic may be implemented in selecting the highest ranked STA). The GO delegates the role of GO to the highest ranked STA, before disconnecting from the P2P network, by providing role related information which includes the intent value for each GC to be used by the highest ranked STA to create a ranking list. In some embodiments, the GO may further establish secure connections on behalf of the highest ranked STA with other GCs using a secure connection method, such as, push-button configuration (e.g., Wi-Fi Protected Setup (WPS) and provide the highest ranked STA access to the established secure connection.

Aspects of the present disclosure overcome these deficiencies and others by maintaining a ranking list used to facilitate delegation of group ownership and maintaining connection of GCs to the P2P network during delegation of group ownership, thereby reducing sensing and power overhead of GCs and maintaining constant connection to the P2P network.

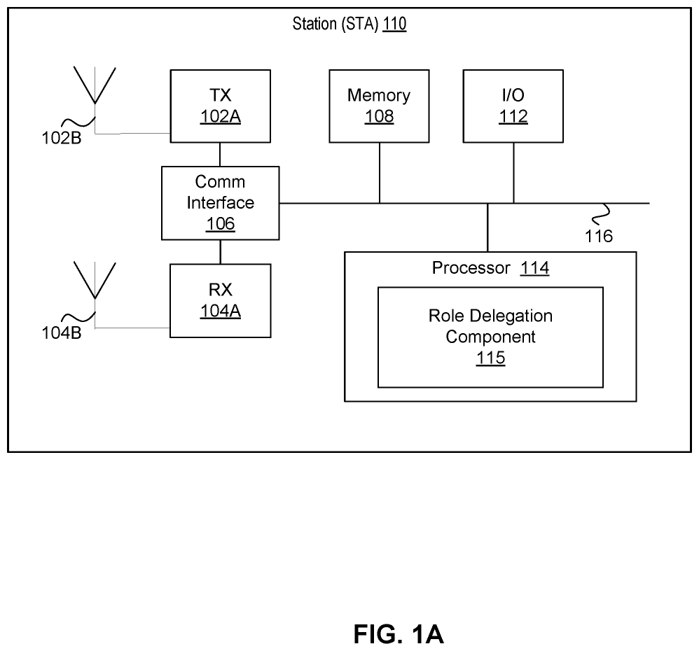

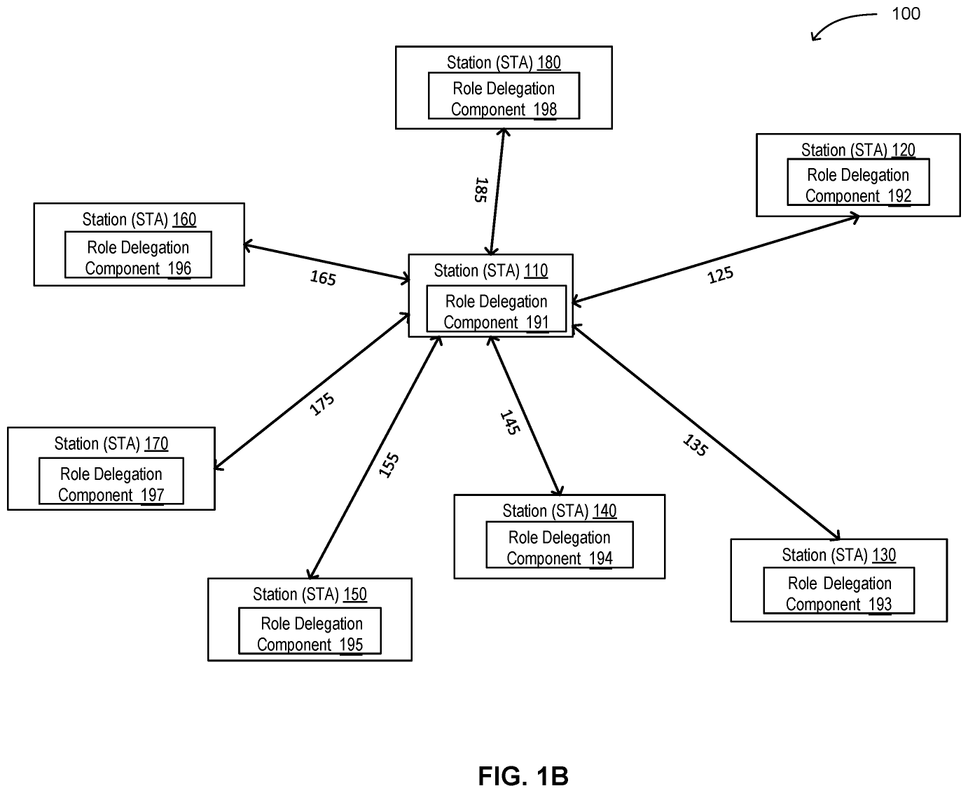

FIG. 1A is a block diagram of an exemplary illustration of a station device (e.g., station device 110). In at least some embodiments, station device 110 includes, but is not limited to, a transmitter 102A, a receiver 104A, a communications interface 106, a transmitter (TX) antenna 102B coupled to the transmitter 102A, a receiver (RX) antenna 104B coupled to the receiver 104A, a memory 108, one or more input/output (I/O) devices 112 (such as a display screen, a touch screen, a keypad, and the like), and a processor 114. In some instances, one or more of the components, such as the memory 108, can be coupled to a communications bus 116. In some embodiments, aspects of the communication interface 106 work with the processor 114 to perform operations or functions as a processing device of the station device 110. In some embodiments, there is a single antenna and multiplexing logic to switch the use of the antenna between the transmitter 102A and receiver 104A. In various embodiments, front end components such as the transmitter 102A, the receiver 104A, the communication interface 106, and the one or more antennas (e.g., TX antenna 102B and/or RX antenna 104B) described herein within various devices are adapted with or configured for WLAN and personal area network (PAN)-based frequency bands, e.g., Bluetooth® (BT), Bluetooth Low Energy (BLE), Wi-Fi™, Zigbee®, Z-wave™, and the like. Processor 114 may include a role delegation component 115.

While FIG. 1A, provides illustration of one or more components of station device 110, station devices 120, 130, 140, 150, 160, 170, and 180 include similar components. Accordingly, each STA of the plurality of STAs includes, but is not limited to, a transmitter, a receiver, a communications interface, a transmitter (TX) antenna coupled to the transmitter, a receiver (RX) antenna coupled to the receiver, a memory, and a processor including the role delegation component 115.

FIG. 1B is a block diagram of an exemplary illustration of an environment 100 that includes a plurality of station devices (STAs) (e.g., STAs 110-180), in accordance with implementations of the present disclosure. The plurality of STAs may establish a wireless network, such as a WLAN P2P network (e.g., P2P network). In particular, a STA of the plurality of STAs (e.g., an initiating STA of the plurality of STAs) initiates discovery of other STAs in the vicinity (e.g., within environment 100) that can establish a P2P network and are set to be discoverable (e.g., the remaining STAs of the plurality of STAs). In particular, the initiating STA sends out discovery signals or probes. The remaining STAs of environment 100 responds to the discovery signals of the initiating STA (e.g., acknowledge the discovery signals). This response typically includes information necessary for establishing a connection, such as device name, device type, supported services, and connection parameters.

After discovery, the plurality of STAs may perform negotiations to determine which STA of the plurality of STAs will take on the role of group owner (e.g., GO) and which STAs will take on the role as group client (e.g., GC). In particular, the plurality of STAs share their intentions to become GO. Intentions of an STA may be represented as an intent value. Intent value is a predefined value that indicates a preference to operate as GO which is influenced by (or determined by) STA's processing power, connectivity options, battery life, etc. Based on the shared intentions, the plurality of STAs agree on which STA (e.g., STA 110) will become GO and designates that STA as the GO. Typically, STA with the highest intention is agreed upon by the plurality of STAs to become GO. Each of the remaining STAs (e.g., STAs 120, 130, 140, 150, 160, 170, and 180) is designated as a GC (e.g., a plurality of GCs). GO acts as an access point in a traditional WLAN network. It manages the P2P network settings, including SSID (Service Set Identifier) and security settings, and controls access to the P2P network. The GCs connect to and communicate through the GO.

After negotiation, the plurality of GCs establishes direct P2P connections 125-185 used to establish the P2P network. In particular, each GC of the plurality of GCs establishes a secure connection (e.g., a direct P2P connection of the direct P2P connections 125-185) with the GO using secure connection methods, such as, for example a Personal Identification Number (PIN) entry, a push-button configuration (e.g., Wi-Fi Protected Setup (WPS), or near field communication (NFC). Each GC exchanges connection information with the GO, which may include service set identifier (SSID), security settings, and other network configuration details that ensures that the GO and GC are configured to communicate effectively. Using the exchanged connection information, the plurality of GCs connect to the GO and the GO accepts the connection. The GO may assign network addresses (like IP addresses) to the plurality of GCs. Once the secure connections (e.g., direct P2P connections 125-185) are established, the plurality of GCs can start communicating, allowing for data transfer, file sharing, streaming, or any other P2P network activities. The GO manages the P2P network, controlling access, and communication between the plurality of GCs. It can also handle new STAs (e.g., new GCs) joining the P2P network or existing STAs (e.g., existing GCs) leaving.

As noted above, each of STAs 110-180 may include a role delegation component similar to role delegation component 115 (e.g., role delegation component 191-198) that facilitates delegation of the role of GO. In particular, the role delegation component 191 of the GO (e.g., STA 110 or a first station device) maintains a list of the plurality of GCs (e.g., a ranking list) used to facilitate delegation of the role of GO from the GO to a GC of the plurality of GCs. The role delegation component 191 of the GO, during negotiation, creates a list of the plurality of GCs with their corresponding intentions (e.g., intent value) (i.e., inserting into the list each GC with their corresponding intent value). The list of the plurality of GCs (or ranking list) may be stored in the GO. In some embodiments, during negotiation, the role delegation component 192-198 of the plurality of STAs may share their reachability value. The reachability value is a value that indicates a number of STAs within environment 100 that are communicatively accessible. The role delegation component 191-198 of each STA may determine its reachability value using various methods, such as, reading from, among other information, various packets, frames, and/or messages transmitted by nearby STAs. Packets can include, for example, transmission control protocol (TCP). Frames can include, for example, beacon frames. Messages can include, for example, keep alive messages. Accordingly, the role delegation component 191 of the GO may, during creation of the list of the plurality of GCs with their corresponding intentions (e.g., intent value), include their corresponding reachability value.

The role delegation component 191 of the GO may calculate, for each STA in the list of the plurality of GCs, a ranking score and include the calculated ranking score with a respective STA in the list of the plurality of GCs. The ranking score is calculated using an intent value of STA and a reachability value of STA. In some embodiments, the ranking score may be calculated by adding the intent value and the reachability value (e.g., sum). In some embodiments, the ranking score may be calculated by averaging the intent value and the reachability value. In some embodiments, the ranking score may be calculated by applying a weight value to the intent value and/or the reachability value and adding the intent value and the reachability value (e.g., weighted sum).

In some embodiments, the role delegation component 192-198 of each GC of the plurality of GCs may share their reachability value with the GO after establishing the wireless network, at regular intervals dictated by a respective GC. For example, the regular intervals of one or more GCs of the plurality of GCs may be identical or different. The role delegation component 191 of the GO may, at periodic time intervals, update the reachability value of each GC of the plurality of GCs in the ranking list. In particular, the most recently received reachability value for a respective GC of the plurality of GCs is used to replace the reachability value of the respective GC of the plurality of GCs in the ranking list. Accordingly, the ranking score is recalculated based on the replaced (or updated) reachability value in the ranking list.

The role delegation component 191 of the GO may initiate delegation of the role of GO from the GO to a GC of the plurality of GCs. In some embodiments, the initiation of the delegation of the role of GO may be in response to the GO indicating a pending disconnection from the P2P network (e.g., due to power loss of the GO or an intent to disconnect). In some embodiments, the initiation of the delegation of the role of GO may be in response a new GC joining the P2P network. In some embodiments, the initiation of the delegation of the role of GO may be in response a ranking score of a GC of the plurality of GCs in the ranking list exceeding a ranking score of the GO. Other conditions and/or scenarios are contemplated to initiate delegation of the role of GO. The role delegation component 191 of the GO identifies, from the ranking list, a GC of the plurality of GCs with the highest-ranking score. In some embodiments, the role delegation component 191 of the GO may determine that one or more GCs of the plurality of GCs have the highest-ranking score. Accordingly, the role delegation component 191 of the GO may prioritize selecting, from the one or more GCs of the plurality of GCs having the highest-ranking score, a GC of the one or more GCs using one or more criteria. The one or more criteria can include, among other criteria contemplated, power source (e.g., wall powered vs battery powered), and highest battery percentage among the battery powered GCs,

For example, in some instances, the role delegation component 191 of the GO may prioritize selecting, from the one or more GCs of the plurality of GCs having the highest-ranking score, a GC of the one or more GCs using an alternating current (AC) connection (e.g., wall powered). In some instances, the role delegation component 191 of the GO may determine that the one or more GCs of the plurality of GCs having the highest-ranking score are all battery powered. Thus, the role delegation component 191 of the GO may prioritize selecting, from the one or more GCs of the plurality of GCs having the highest-ranking score, a GC of the one or more GCs with the highest battery percentage. In some instances, the role delegation component 191 of the GO may determine that the one or more GCs of the plurality of GCs having the highest-ranking score have the same battery percentage. Thus, the role delegation component 191 of the GO may randomly select, from the one or more GCs of the plurality of GCs having the highest-ranking score, a GC of the one or more GCs. The GC of the plurality of GCs selected by the role delegation component 191 of the GO is set as a highest ranked station or highest ranked STA (e.g., second station device).

The role delegation component 191 of the GO delegates the role of GO to the highest ranked STA. In particular, the GO provides role related information (e.g., DHCP server details, a group identification, client state, etc.) to the highest ranked STA. The role related information may include the intent value for each GC of the plurality of GCs to be used by the highest ranked STA to create a ranking list.

In some embodiments, the GO may have sufficient time before disconnection from the P2P network. Accordingly, to delegate the role of GO, the role delegation component 191 of the GO establishes the secure connection on behalf of the highest ranked STA using a secure connection method, such as, push-button configuration (e.g., Wi-Fi Protected Setup (WPS). For example, the GO generates the encryption keys for the plurality of GCs using a current secure connection with the GO and provides the encryption keys for the plurality of GCs to the highest ranked STA. Thus, the highest ranked STA may establish the secure connection to the plurality of GCs using the encryption keys.

Once, the GO provides the encryption keys for the plurality of GCs to the highest ranked STA, the GO may disconnect from the P2P network. In other embodiments, since the GO may not have much time before disconnection from the P2P network, the GO disconnects after providing the role related information including the intent value for each GC of the plurality of GCs to be used by the highest ranked STA to create a ranking list. Thus, the process of establishing the secure connection between the highest ranked STA and the plurality of GCs is left to the highest ranked STA. In particular, the highest ranked STA may establish the secure connection using the secure connection method.

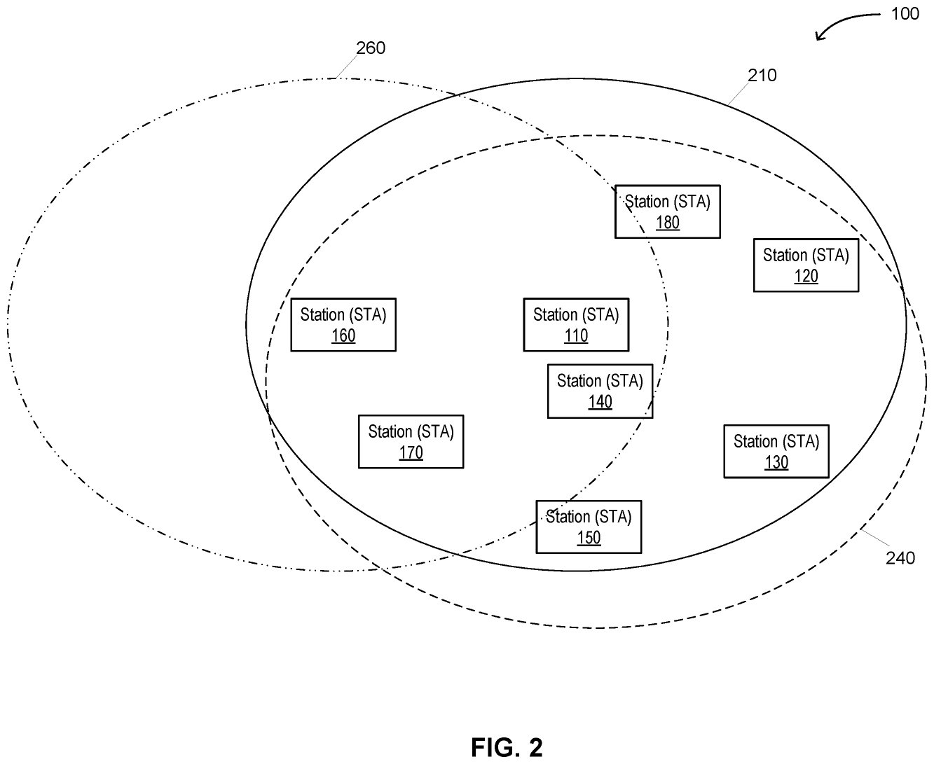

FIG. 2 is a block diagram of an exemplary illustration of environment 100 of FIG. 1 in which a delegation of the role of GO affects the P2P network, in accordance with implementations of the present disclosure. Similar to FIG. 1, environment 100 includes a plurality of station devices (STAs) (e.g., STAs 110-180).

STA 110 of the plurality of STAs may be designated the role of GO (e.g., GO), and STA 120-180 may be designated the role of GC (e.g., GCs). A communication range 210 of STA 180 allows for the establishment of a P2P network (via direct P2P connections between STA 110 and STA 120-180, not shown). Communication range, such as communication range 210, 240, and 260, refers to the maximum distance over which a station (e.g., STA 110, STA 140, and STA 160, respectively) can effectively transmit and receive signals.

In response to the initiation of the delegation of the role of GO, STA 110 may determine that STA 160 should be delegated the role of GO based on intent value. A communication range 260 of STA 160 allows for the establishment of a P2P network (via direct P2P connections between STA 160 and STA 170, not shown). As a result, STA 120, 130, 140, 150, and 180, will be disconnected from the P2P network.

In response to the initiation of the delegation of the role of GO, STA 110 may determine that STA 140 should be delegated the role of GO based on a ranking score obtained from a ranking list of STA 110. The communication range 240 of STA 140 allows for the establishment of a P2P network (via direct P2P connections between STA 140 and STA 120, 130, 150, 160, 170, and 180, not shown). As a result, no (or fewer) STAs were unwillingly disconnected from the P2P network.

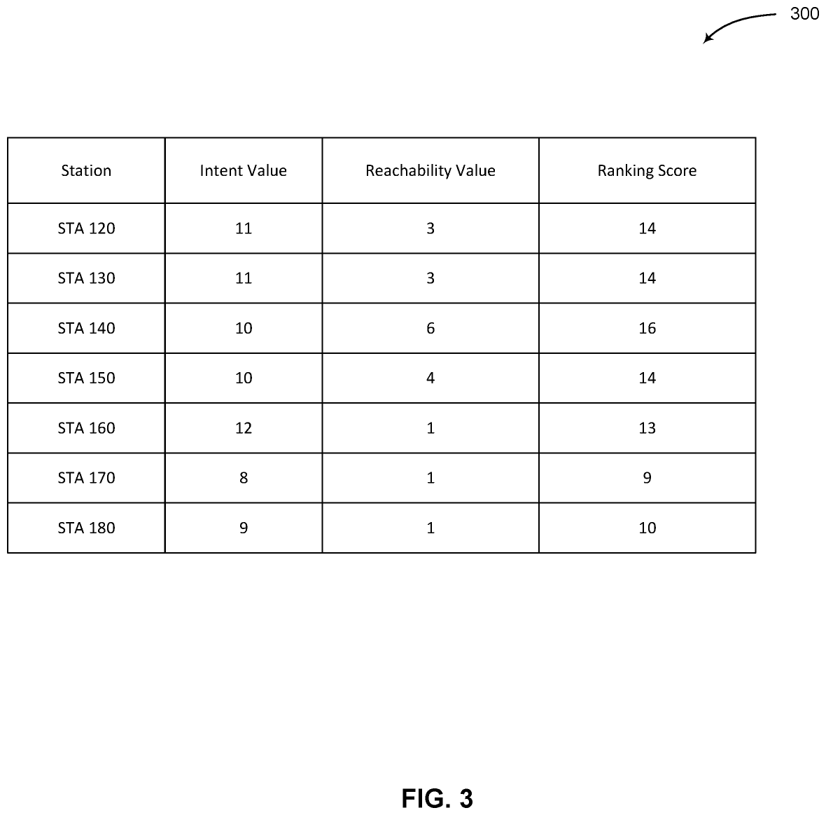

FIG. 3 is an illustration of a ranking list 300 maintained by a GO of the P2P network, in accordance with implementations of the present disclosure. Ranking list 300 includes a plurality of entries. Each entry of the plurality of entries corresponds to a STA of the plurality of STAs (e.g., STA 120, 130, 140, 150, 160, 170, and 180 of FIG. 1). Each entry includes an identifier of STA of the plurality of STAs, an intent value, a reachability score, and a ranking score.

The intent value for a specific STA is a predefined value that indicates a preference for the specific STA to operate as GO which is influenced by (or determined by) the specific STA's processing power, connectivity options, battery life, etc. The reachability value for a specific STA is a value that indicates a number of STAs within environment 100 that fall within a communication range of the specific STA (i.e., are communicatively accessible). With quick reference to FIG. 2, while the intent value for STA 160 (e.g., 12) is greater than the intent value for STA 140 (e.g., 10), the reachability value for STA 160 (e.g., 1) is less than the reachability value for STA 140 (e.g., 6). As a result, a ranking score for STA 160 (e.g., 13) is less than a ranking score for STA 140 (e.g., 16) indicating that STA 140 is better suited for the role of GO over STA 160.

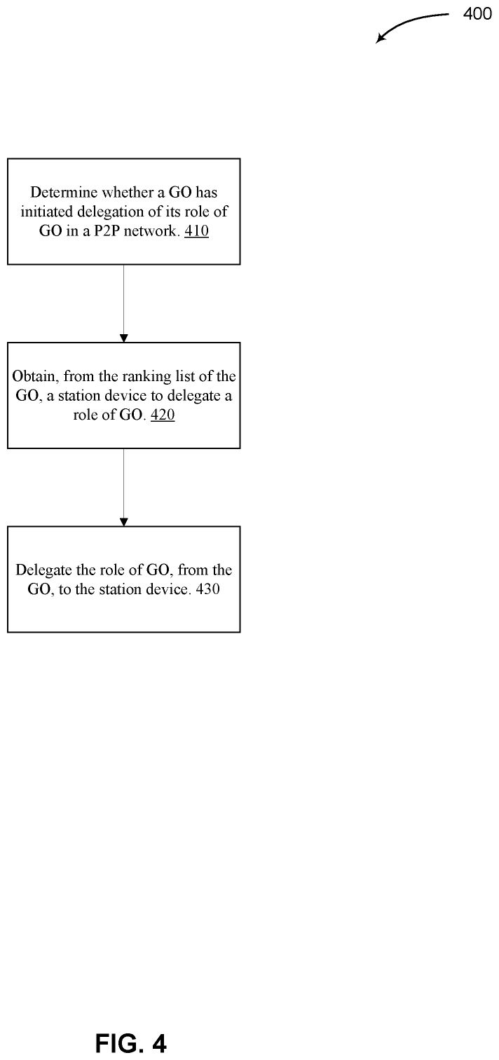

FIG. 4 is a flow diagram of a method 400 of delegating group ownership from one station device to another station device, in accordance with implementations of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the GO, including the role delegation component 115 (of FIG. 1), role delegation component 191-198 (of FIG. 2), and/or the processor (e.g., processing device).

At operation 410, the processing logic determines whether a GO has initiated delegation of its role of GO in a P2P network. As previously described, the initiation of the delegation of the role of GO may be in response to the GO indicating a pending disconnection from the P2P network (e.g., due to power loss of the GO or an intent to disconnect), a new GC joining the P2P network, or a ranking score of a GC in the ranking list exceeding a ranking score of the GO. The ranking list, which is stored in the GO, includes, for each GC, an intent value, a reachability value, and a ranking score calculated based on the intent value and the reachability value. The intent value is a predefined value that indicates a preference of the GO. The reachability value is a value that indicates a number of GCs that are communicatively accessible by a respective GC.

At operation 420, the processing logic obtains, from the ranking list of the GO, a station device to delegate a role of GO. As previously described, the station device may be selected from the ranking list by identifying the station device (or GC) with the highest-ranking score. In some embodiments, if more than one station device (or GC) has the highest-ranking score, the station device using AC connection is prioritized. If the more than one station device having the highest-ranking score is battery operated instead of AC connection, the station device of the more than one station device having the highest-ranking score with the highest battery percentage is prioritized. If the more than one station device having the highest-ranking score has the same battery percentage, a station device of the more than one station device having the highest-ranking score is selected at random. Alternatively, rather than prioritizing AC connection and/or battery percentage, a station device of the more than one station device having the highest-ranking score is selected at random.

At operation 430, the processing logic delegates the role of GO, from the GO, to the station device. As previously described, the GO delegates the role to the station device by providing the role related information including the intent value for each station (or GC) of the plurality of station devices (e.g., GCs) to be used by the highest ranked STA to create a new ranking list. Depending on the amount of time the GO has before disconnection from the P2P network, the GO may establish secure connections, on behalf of the station device, with the remaining station devices using various secure connection methods. Once established, the GO provides information regarding the secure connection (e.g., encryption keys) to the station device. The GO establishes secure connections on behalf of the station device if there is sufficient time left before disconnection.

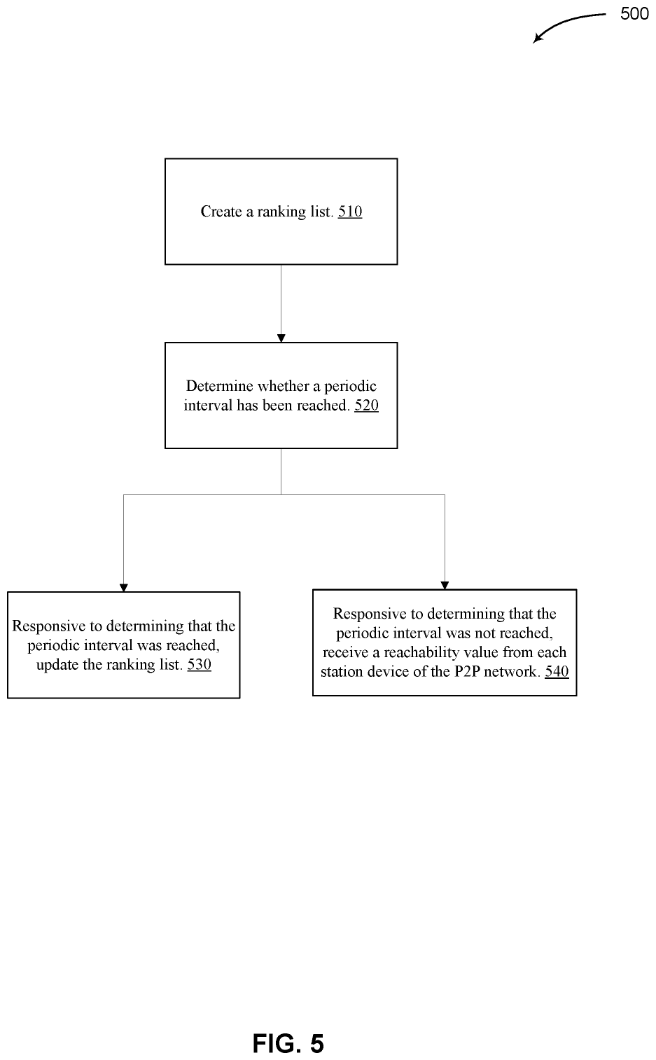

FIG. 5 is a flow diagram of a method 500 of maintaining a ranking list for delegating group ownership from one station device to another station device, in accordance with implementations of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the GO, including the role delegation component 115 (of FIG. 1), role delegation component 191-198 (of FIG. 2), and/or the processor (e.g., processing device).

At operation 510, the processing logic creates a ranking list. As previously described, in some embodiments, during negotiation to establish a P2P network with a plurality of station devices. A station device designated as GO (e.g., GO) may receive from each station device of the remaining station devices of the plurality of station devices designated as GC (e.g., plurality of GCs) an intent value. In some embodiments, each GC of the plurality of GCs may share, in addition with the intent value, a reachability value. The reachability value is a value that indicates a number of GCs of the plurality of GCs that are communicatively accessible. The reachability value may be determined using various methods, such as, reading from, among other information, various packets, frames, and/or messages transmitted by nearby station devices. The GO may calculate, for each GC of the plurality of GCs, a ranking score based on a respective intent value and respective reachability value. In some embodiments, the ranking score may be calculated by adding the intent value and the reachability value. In some embodiments, the ranking score may be calculated by averaging the intent value and the reachability value. In some embodiments, the ranking score may be calculated by applying a weight value to the intent value and/or the reachability value and adding the intent value and the reachability value.

At operation 520, the processing logic determines whether a periodic interval has been reached. The periodic interval may be a period of time between actions occurring. At operation 530, responsive to determining that the periodic interval was reached, the processing logic updates the ranking list. As previously described, a most recently received reachability value for each GC of the plurality of GCs is used to replace the reachability value of a respective GC of the plurality of GCs in the ranking list. Accordingly, the ranking score is recalculated based on the replaced (or updated) reachability value in the ranking list.

At operation 540, responsive to determining that the periodic interval was not reached, the processing logic receives a reachability value from each station device of the P2P network. At regular intervals, each GC of the plurality of GCs shares their reachability value with the GO based on their (e.g., respective GC) dictated intervals. In summation, the ranking list is not updated based on receiving reachability values from the plurality of GCs but rather triggered by in response to each periodic interval of the GO being reached.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A first station device of a plurality of station devices in a peer-to-peer (P2P) network, wherein a processor of the first station device is to perform operations comprising:
responsive to a pending disconnection of the first station device from the P2P network, identifying, from a list of the plurality of station devices maintained by the first station device, a second station device to delegate ownership of the P2P network; and
delegating ownership from the first station device to the second station device.

2. The first station device of claim 1, wherein delegating ownership from the first station device to the second station device comprises:
providing an intent value associated with each station device in the list to the second station device; and
causing the second station device to take ownership of the P2P network.

3. The first station device of claim 1, wherein delegating ownership from the first station device to the second station device comprises:
generating one or more encryption keys for the plurality of station devices;
providing the one or more encryption keys to the second station device;
providing, from the list, an intent value associated with each station device of the plurality of station devices to the second station device; and
causing the second station device to take ownership of the P2P network.

4. The first station device of claim 1, wherein the processor of the first station device is to perform operations further comprising:
responsive to establishing the P2P network, receiving, from each station device of the plurality of station devices, an intent value and a reachability value; and
generating the list by inserting, into the list, each station device of the plurality of station devices with a corresponding intent value and a corresponding reachability value.

5. The first station device of claim 4, wherein the reachability value is a number of station devices of the plurality of station devices that are within a communication range of a respective station device.

6. The first station device of claim 1, wherein the processor of the first station device is to perform operations further comprising:
receiving, from the plurality of station devices, a plurality of reachability values, wherein each reachability value of the plurality of reachability values corresponds to a station device of the plurality of station devices;
updating, based the plurality of reachability values, the list; and
identifying a station device in the list identified as a highest ranked station device based on the intent value and the reachability value.

7. The first station device of claim 1, wherein the P2P network is a wireless local area network (WLAN) established among the plurality of station devices.

8. A wireless network comprising:
a first station device of a plurality of station devices operating as an owner of the wireless network, wherein a processor of the first station device is to perform operations comprising:
periodically receiving, from the plurality of station devices, a plurality of reachability values, wherein each reachability value of the plurality of reachability values corresponds to a station device of the plurality of station devices;
for each predetermined time interval, updating, using the plurality of reachability values, a list of the plurality of station devices maintained by the first station device, wherein each station device in the list includes a corresponding intent value and a corresponding reachability value; and
identifying, based on the list, a station device in the list designated as a highest ranked station device to delegate ownership in response to a pending disconnection of the first station device.

9. The wireless network of claim 8, wherein the wireless network is a wireless local area network (WLAN) established among the plurality of station devices.

10. The wireless network of claim 8, wherein the processor of the first station device is to perform operations further comprising:
responsive to the pending disconnection of the first station device, obtaining, from the list, the highest ranked station device; and
delegating ownership to the highest ranked station device.

11. The wireless network of claim 10, wherein delegating ownership to the highest ranked station device comprises:
providing an intent value associated with each station device in the list to the highest ranked station device.

12. The wireless network of claim 10, wherein delegating ownership to the highest ranked station device comprises:
generating one or more encryption keys for the plurality of station devices;
providing the one or more encryption keys to the highest ranked station device; and
providing an intent value associated with each station device in the list to the highest ranked station device.

13. The wireless network of claim 8, wherein each reachability value is a number of station devices of the plurality of station devices that are within a communication range of a respective station device.

14. A method comprising:
maintaining, by a first station device of a plurality of station devices of a wireless network, a list of the plurality of station devices, wherein each station device in the list includes an intent value and a reachability value.

15. The method of claim 14, further comprising:
responsive to a pending disconnection of the first station device, delegating ownership of the wireless network from the first station device to a station device identified as a highest ranked station device, in the list, based on the intent value and the reachability value.

16. The method of claim 14, wherein the wireless network is a wireless local area network (WLAN) established among the plurality of station devices.

17. The method of claim 14, further comprising:
responsive to establishing the wireless network for the plurality of station devices, generating, by the first station device, the list.

18. The method of claim 17, wherein generating, by the first station device, the list comprises:
receiving, by the first station device, an intent value and a reachability value from each station device of the plurality of station devices; and
inserting, by the first station device into a list, each station device of the plurality of station devices with a corresponding intent value and a corresponding reachability value; and
storing, by the first station device, the list.

19. The method of claim 14, wherein maintaining, by the first station device, the list comprises:
receiving, by the first station device, a current reachability value from each station device of the plurality of station devices; and
for each predetermined time interval, updating, by the first station device, a reachability value of each station device in the list with a corresponding current reachability value.

20. The method of claim 14, wherein the reachability value is a number of station devices of the plurality of station devices that are within a communication range of a respective station device.
